(19) United States
(12) Patent Application Publication
(10) Pub. No.: US 2010/0231462 A1
(43) Pub. Date: Sep. 16, 2010

(54) MULTI-BAND SERIALLY CONNECTED ANTENNA ELEMENT FOR MULTI-BAND WIRELESS COMMUNICATION DEVICES

(75) Inventor: Allen Minh-Triet Tran, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/404,191

(22) Filed: Mar. 13, 2009

(51) Int. Cl. H01Q 1/24; H01Q 1/38; H01Q 21/30

(52) U.S. Cl. 343/702; 343/700 MS; 343/893

(57) ABSTRACT

A multi-band antenna including a high-band antenna and a low-band antenna coupled in serial cascade fashion, where the low-band antenna is coupled at a position relative to the high-band antenna characterized by low coupling between the low-band antenna and the high-band antenna in corresponding operating frequency bands. In one exemplary embodiment, the high-band antenna is a high-band modified monopole antenna. In another, the high-band modified monopole antenna is a high-band quarter ellipse monopole antenna element and the low-band antenna is a low-band modified monopole antenna.

### TECHNICAL FIELD

The present disclosure relates generally to radio frequency (RF) antennas, and more specifically to multi-band RF antennas.

### BACKGROUND

In many wireless communication devices there is a requirement to support multiple frequency bands and operating modes. Some examples of operating modes include GSM, CDMA, WCDMA, LTE, EVDO—each in multiple frequency bands (CDMA450, US cellular CDMA/GSM, US PCS CDMA/GSM/WCDMA/LTE/EVDO, IMT CDMA/WCDMA/LTE, GSM900, DCS), short range communication links (Bluetooth, UWB), broadcast media reception (MediaFLO, DVB-H), high speed internet access (UMB, HSPA, 802.11a/b/g/n, EVDO), and position location technologies (GPS, Galileo). Therefore, with each of these modes in a multi-band wireless communication device, the number of radios and frequency bands is incrementally increased and the complexity and design challenges for a multi-band antenna supporting each frequency band may increase significantly.

One solution for a multi-band antenna is to combine multiple single-band antennas in parallel. The main disadvantage of this design technique is the large size required to accommodate multiple antennas in different operating frequency bands as well as a potential degradation in radiated antenna efficiency for one or more of the operating bands. Another common solution for a multi-band antenna is to manipulate the multiple resonant frequencies of a single antenna. The main drawback of this design technique is that the operating frequency bands must be close together in frequency to the resonant harmonic frequencies of the antenna structure.

Another common solution for a multi-band antenna is to design a complex folded 2-d or 3-d structure that resonates in multiple frequency bands. Controlling the multi-band antenna port impedance as well as enhancing the antenna radiation efficiency (across a wide range of operating frequency bands) is restricted by the geometry of the multi-band antenna structure and the matching circuit between the multi-band antenna and the radio(s) within the multi-band wireless communication device. Often when this design approach is taken, the geometry of the antenna structure is very complex and the physical area/volume of the antenna increases.

With the limitations on designing multi-band antennas with high antenna radiation efficiency and associated matching circuits, another solution is utilizing multiple antenna elements to cover multiple operative frequency bands. In a particular application, a cellular phone with US cellular, US PCS, and GPS radios may utilize one antenna for each operative frequency band (each antenna operates in a single radio frequency band). The drawbacks to this approach are additional area/volume and the additional cost of multiple single-band antenna elements.

In certain applications of multi-band antennas, the multi-band antenna match is adjusted electronically (with a single-pole multi-throw switch) to select an optimal match for the multi-band antenna (with 50 ohms) at a particular operative frequency band; i.e., between US cellular, US PCS, and GPS is but one example. In this instance, the multi-band antenna performance (radiation efficiency) may degrade as more frequency bands are added, as the multi-band antenna structure is not changed for different operative frequency bands.

There is a need for a compact multi-band antenna with improved radiation efficiency across a broad range of operative frequencies for multi-band wireless communication devices.

### BRIEF DESCRIPTION OF THE DRAWINGS

FIG. 1 shows a two dimensional drawing in the XY plane of multi-band wireless communication device with a high-band modified monopole antenna for use in a multi-band serially connected antenna.

FIG. 2 shows a two dimensional drawing in the XY plane of a low-band modified monopole antenna for use in a multi-band serially connected antenna.

FIG. 3 shows a two dimensional drawing in the XY plane of multi-band wireless communication device with a multi-band antenna (comprised of the antenna elements from FIG. 1 and FIG. 2) in accordance with an exemplary embodiment.

FIG. 4 shows a magnified two dimensional drawing view in the XY plane of the multi-band wireless communication device with the multi-band antenna of FIG. 3.

FIG. 5 shows a magnified two dimensional drawing view in the XY plane of the multi-band antenna of FIG. 3 including LC networks coupled between the antenna elements from FIG. 1 and FIG. 2.

FIG. 6 shows a three dimensional drawing of the multi-band wireless communication device with the multi-band antenna formed by a serial connection of the high-band modified monopole antenna from FIG. 1 in the XY plane and the low-band modified monopole antenna from FIG. 2 rotated θ degrees in the YZ plane.

FIG. 7 shows a three dimensional drawing of the multi-band wireless communication device with the multi-band antenna formed by a serial connection of the high-band modified monopole antenna from FIG. 1 and the low-band modified monopole antenna from FIG. 2, both antenna elements rotated θ degrees in the YZ plane relative to the ground plane in the XY plane.

FIG. 8 shows a graph of the high-band modified monopole antenna and multi-band antenna return loss (0.6 to 2.2 GHz) for the antenna elements shown in FIGS. 1-4.

FIG. 9 shows a graph of the high-band modified monopole antenna and multi-band antenna radiation efficiency (0.6 to 2.2 GHz) for the antenna elements shown in FIGS. 1-4.

To facilitate understanding, identical reference numerals have been used where possible to designate identical elements that are common to the figures, except that suffixes may be added, when appropriate, to differentiate such elements. The images in the drawings are simplified for illustrative purposes and are not necessarily depicted to scale.

The appended drawings illustrate exemplary configurations of the disclosure and, as such, should not be considered as limiting the scope of the disclosure that may admit to other equally effective configurations. Correspondingly, it has been contemplated that features of some configurations may be beneficially incorporated in other configurations without further recitation.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

The detailed description set forth below in connection with the appended drawings is intended as a description of exemplary embodiments of the present invention and is not intended to represent the only embodiments in which the present invention can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the invention. It will be apparent to those skilled in the art that the exemplary embodiments of the invention may be practiced without these specific details. In some instances, well known structures and devices are shown in block diagram form in order to avoid obscuring the novelty of the exemplary embodiments presented herein.

The device described therein may be used for various multi-band antenna designs including, but not limited to multi-band wireless communication devices for cellular, PCS, and IMT frequency bands and air-interfaces such as CDMA, TDMA, FDMA, OFDMA, and SC-FDMA. In addition to cellular, PCS or IMT network standards and frequency bands, this device may be used for local-area or personal-area network standards, WLAN, Bluetooth, & ultra-wideband (UWB), broadcast media reception (MediaFLO, DVB-H), high speed local area internet access (UMB, 802.11a/b/g/n), and position location technologies (GPS, Galileo).

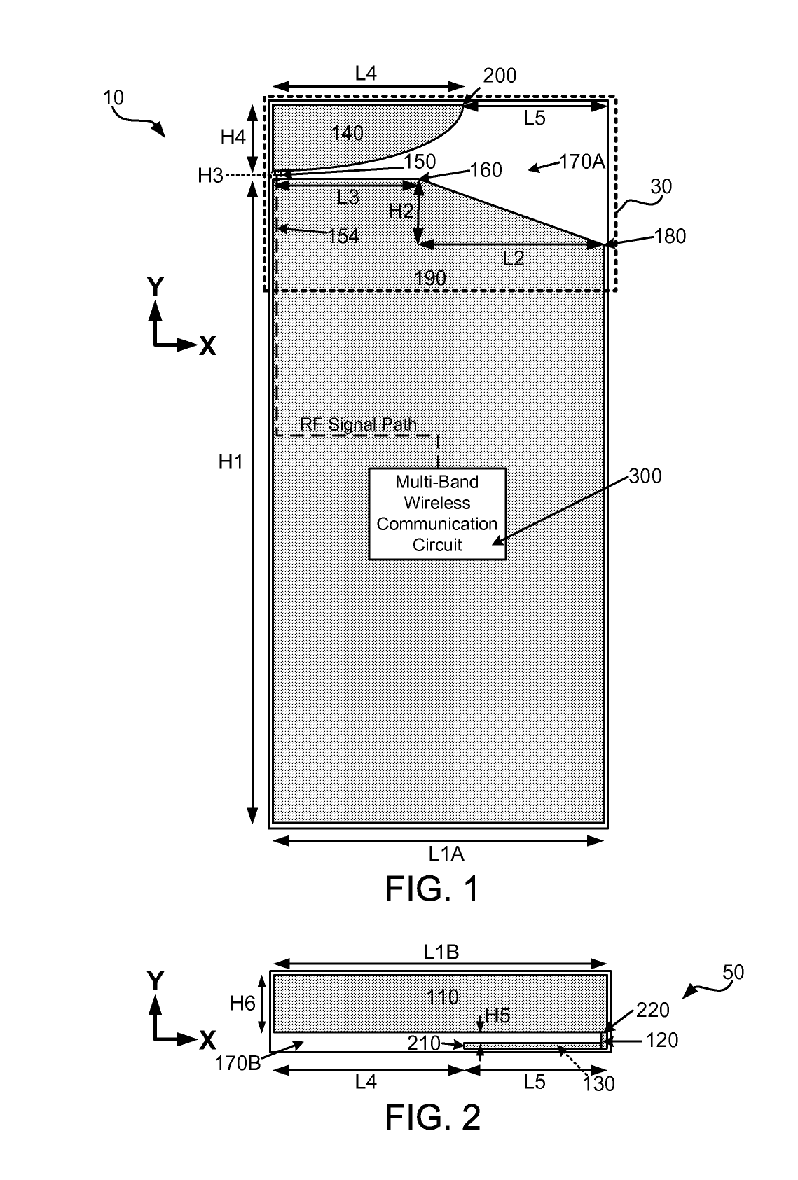

FIG. 1 shows a two dimensional drawing in the XY plane of multi-band wireless communication device with a high-band modified monopole antenna for use in a multi-band serially connected antenna in accordance with an exemplary embodiment. For purposes of this disclosure, a high-band modified monopole antenna 30 is an antenna with a tapered modified monopole antenna element as shown by a high-band modified monopole antenna element 140 (quarter ellipse). Other possible shapes for high-band modified monopole antenna 30 may include any tapered two-dimensional structure, including a quarter ellipse, half-ellipse, a quarter circle, a half-circle, or the like.

High-band modified monopole antenna 30 is etched or deposited metal (typically copper) on a printed circuit board 170A (a typical design example with a dielectric constant consistent with FR4 or similar material (typically εᵣ=4.3 and an overall thickness of 1 mm). As shown in FIG. 1, High-band modified monopole antenna 30 is comprised of a high-band quarter ellipse monopole antenna element 140, a flat metal (2-d) quarter ellipse monopole element with dimensions H4 and L4 to define the operating frequency range.

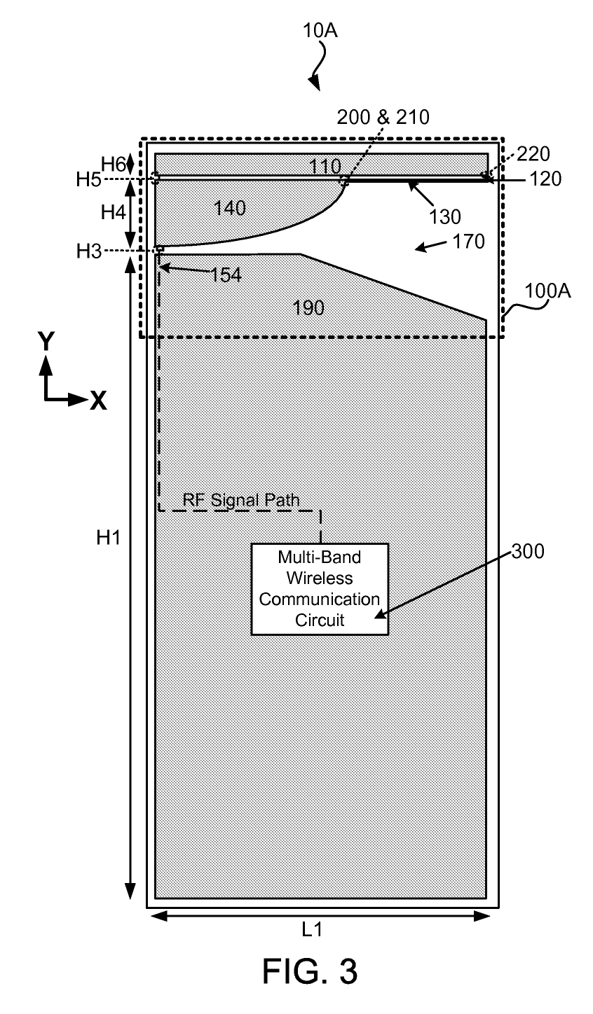

Although the advantages of planar elliptical and circular monopole antenna elements for broadband frequency coverage are known in the art, their physical size limits applications for portable or handheld multi-band wireless communication devices. As a result, with proper optimization for a particular operating band, high-band quarter ellipse monopole antenna element 140 offers similar broad operating frequency range with a quarter of the physical area of prior circular or elliptic metal antenna structures. One of the key physical characteristics affecting electrical performance of high-band modified monopole antenna 30 is the taper or curvature of high-band quarter ellipse monopole antenna element 140 away from a reference ground plane (ground plane 190). Dimensions L2 and H2 will be discussed in relation to the exemplary embodiments shown in FIGS. 3-7 in more detail.

As a result of the taper introduced by the geometry and physical dimensions of the high-band quarter ellipse monopole antenna element 140, high-band modified monopole antenna 30 is optimized for a wide operating frequency range in conjunction with a multi-band wireless communication circuit 300. In one example design, the dimensions L4 and H4 are 23 mm and 8 mm respectively. The corresponding operating frequency range includes 1575-2200 MHz (GPS, K-PCS, DCS, US-PCS, and IMT frequency bands) when the dielectric constant of printed circuit board 170A is 4.3 (typical value for FR4 material).

Other features of high-band modified monopole antenna 30 include a first radio frequency port 150 with a gap height H3. Gap height H3 is typically 1 mm in this example, but different values may be needed depending on the required operating frequency range. Other physical dimensions include L1A, L5 and H1 which are defined by the physical size of ground plane 190 of printed circuit board 170A and are not critical to the operating frequency range of the high-band modified monopole antenna 30 with high-band quarter ellipse monopole antenna element 140 as long as L1A>L4 and L1A=L4+L5.

As shown in FIG. 1, L4 equals 0.575×L1A, but other ratios (L4/L1A) are possible depending on the physical size of printed circuit board 170A and the operating frequency range of high-band modified monopole antenna 30 with multi-band wireless communication circuit 300. Multi-band wireless communication circuit 300 connects to a first radio frequency port 150 via a wireless communication circuit RF signal path 154 (RF signal path in FIG. 1). Wireless communication circuit RF signal path 154 is not limited to but may include a 50 ohm metal trace embedded on substrate 170A (coplanar with ground plane 190 or on a separate layer), a 50 ohm balanced signal pair from end-to-end, or a coaxial cable.

A second radio frequency port 200 is located at or near the vertex of the high-band quarter ellipse monopole antenna element 140 curve furthest from the ground plane 190. The second radio frequency port 200 may be serially connected or coupled to another antenna radio frequency port.

FIG. 2 shows a two dimensional drawing in the XY plane of a low-band modified monopole antenna for use in a multi-band serially connected antenna in accordance with an exemplary embodiment. For purposes of this disclosure, a low-band modified monopole antenna 50 includes a modified monopole antenna element 110. Other possible shapes for low-band modified monopole antenna 50 may include many possible two-dimensional structures, including any polygon shape such as a rectangular transmission line (as shown in FIG. 2), meandering line, or the like.

Low-band modified monopole antenna 50 includes a modified monopole element comprising a modified monopole antenna element 110, transmission lines 120 and 130. The low-band modified monopole antenna 50 radiating element is a modified monopole antenna element 110 with physical dimensions L1B and H6 (rectangular in this exemplary embodiment).

Other possible configurations for the low-band modified monopole antenna 50 with modified monopole antenna element 110 may include a meandering line or the like depending on the dimension L1B, the operating frequency range for low-band modified monopole antenna 50, and available area on printed circuit board 170B. L1B may equal L1A or may be a different value depending on the physical orientation of low-band modified monopole antenna 50.

As shown in FIG. 2, transmission line 120 connects between transmission line 130 and one corner of modified monopole antenna element 110 at a third radio frequency port 220. Transmission line 120 has physical dimensions of 0.2 mm (width) and 0.5 mm (length). The input impedance of the third radio frequency port 220 depends on the physical dimensions of modified monopole antenna element 110 and the operating frequency range.

A fourth radio frequency port 210 for the low-band modified monopole antenna 50 is on the left end of transmission line 130 with a physical length L5, a gap H5 between modified monopole antenna element 110 and transmission line 130. H3 is approximately 0.5 mm, but other values are possible depending on the physical constraints of printed circuit board 170B. The transmission line width for transmission lines 120 and 130 is approximately 0.2 mm (not shown).

The input impedance of the fourth radio frequency port 210, for low-band modified monopole antenna 50, is configured (by utilizing narrow line width and predetermined length) as a high-impedance circuit over the operating frequency range of the high-band modified monopole antenna 30 shown previously in FIG. 1.

In one example design, the dimensions L1B and H6 are 40 mm and 2.5 mm respectively when the dielectric constant of printed circuit board 170B is 4.3 (typical value for FR4 material). The corresponding operating frequency range includes 824-894 MHz (US Cellular) when low-band modified monopole antenna 50 is serially connected to high-band modified monopole antenna 30 (of FIG. 1) and the dielectric constant of printed circuit board 170A is 4.3 (typical value for FR4 material). With further optimization for particular printed circuit board 170B physical dimensions, low-band modified monopole antenna 50 may cover even wider frequency ranges, but may not overlap the high-band modified monopole antenna 30 operating frequency range.

FIG. 3 shows a two dimensional drawing in the XY plane of multi-band wireless communication device with a multi-band antenna (comprised of the antenna elements from FIG. 1 and FIG. 2) in accordance with an exemplary embodiment as shown. A multi-band antenna 100A is formed when low-band modified monopole antenna 50 (from FIG. 2) is connected in series with high-band modified monopole antenna 30 (from FIG. 1) at the junction of the second radio frequency port 200 with the fourth radio frequency port 210. In this design example, L1 equals L1A and L1B from FIGS. 1-2 and all the metal structures are planar (one layer of printed circuit board 170). However, in other exemplary embodiments, the metal structures may reside on different dielectric layers of printed circuit board 170 and are connected (where appropriate) by metal via contacts between the dielectric layers). Vertices 160 and 180 as well as L2, H2, and L3 are optimized for the operating frequency range of low-band modified monopole antenna 50 (from FIG. 2) serially connected with high-band modified monopole antenna 30 (from FIG. 1) at the fourth radio frequency port 210 and the second radio frequency port 200 respectively.

In one exemplary embodiment, multi-band antenna 100A is formed as a three dimensional metalized structure.

As mentioned previously in reference to FIG. 2, low-band modified monopole antenna 50 is designed to present a high-impedance at the fourth radio frequency port 210 and minimize low-band modified monopole antenna 50 coupling into high-band modified monopole antenna 30. However, an inductor-capacitor circuit (LC network) may also be placed in series between the fourth radio frequency port 210 and the second radio frequency port 200 to improve the isolation and/or matching between high-band modified monopole antenna 30 and low-band modified monopole antenna 50 in operating frequency bands for multi-band antenna 100A.

The corresponding operating frequency range for multi-band antenna 100A includes 824-894 MHz (US Cellular) along with 1575-2200 MHz (GPS, US-PCS) when the dielectric constant of printed circuit board 170A is 4.3 (typical value for FR4 material). With further optimization for particular printed circuit board 170 physical dimensions and the dimensions of high-band modified monopole antenna 30 and low-band modified monopole antenna 50, multi-band antenna 100A may cover different operating frequency ranges.

As discussed previously in reference to FIG. 1, multi-band wireless communication circuit 300 connects to the first radio frequency port 150 via wireless communication circuit RF signal path 154 (RF signal path 154 in FIG. 1, FIG. 3, and FIG. 5). Wireless communication circuit RF signal path 154 is not limited to but may include a 50 ohm metal trace embedded on substrate 170A (coplanar with ground plane 190 or on a separate layer), a 50 ohm balanced signal pair from end-to-end, or a coaxial cable.

Multi-band antenna 100A offers excellent radiation efficiency across a wide range of operating frequencies with a minimum of circuit complexity and physical volume. Multi-band antenna 100A replaces the functionality of multiple single-band antennas for different frequency bands and reduces the overall size of the antenna system; thereby circuit board floor-plan and layout are simplified, multi-band wireless communication device size is reduced, and ultimately the multi-band wireless communication device features and form are enhanced.

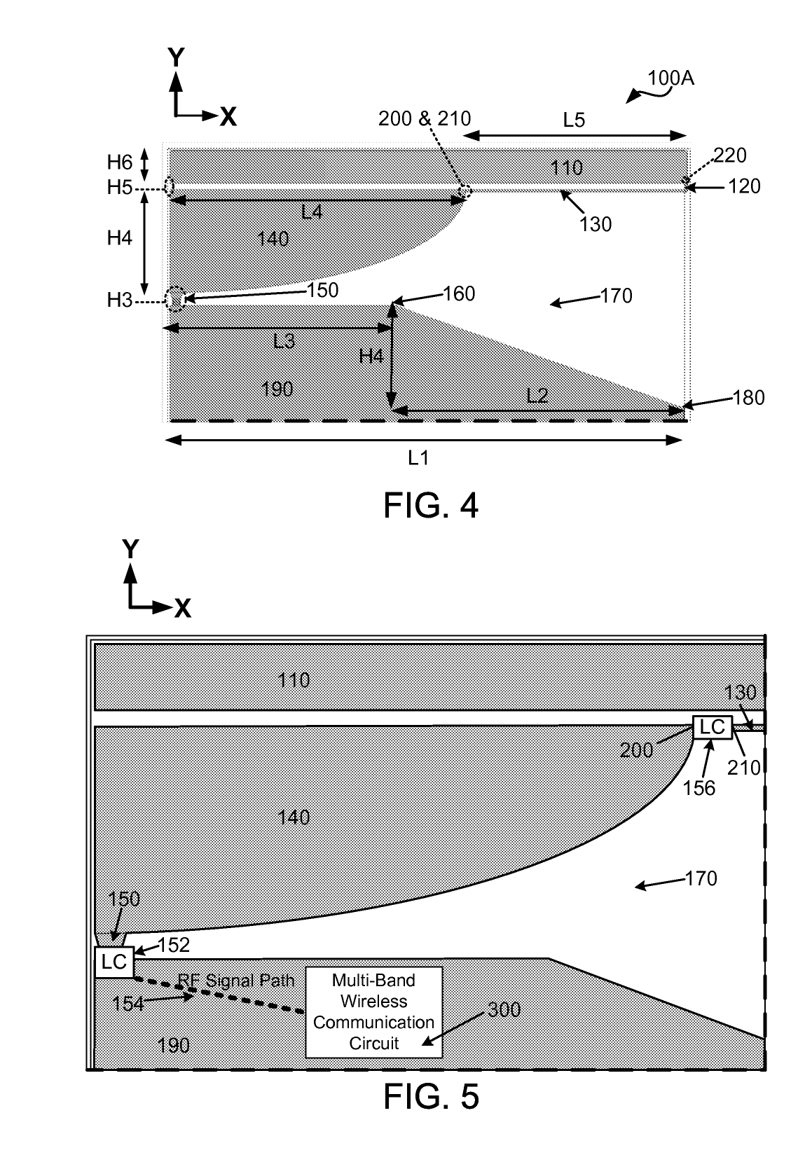

FIG. 4 shows a magnified two dimensional drawing view in the XY plane of the multi-band antenna in accordance with the exemplary embodiment as shown. FIG. 4 shows more clearly the gaps H3 and H5 as well as the connection between low-band modified monopole antenna 50 (at the fourth radio frequency port 210), high-band modified monopole antenna 30 (at the second radio frequency port 200), and the first radio frequency port 150. Ground plane 190 is cut along a dashed line indicated at the bottom of FIG. 4 to allow a close-up view of the multi-band antenna 100A structure. As shown previously in relation to FIG. 3, L1 equals L1A and L1B from FIGS. 1-2.

FIG. 5 shows a magnified two dimensional drawing view in the XY plane of the multi-band antenna of FIG. 3 including LC networks coupled between the antenna elements from FIG. 1 and FIG. 2 in accordance with the exemplary embodiment as shown. Ground plane 190 and low-band modified monopole antenna 50 are cut along a dashed line indicated at the bottom and right sides of FIG. 5 to allow a close-up view of where the LC networks 152 and 156 are physically located. LC networks 152 and 156 are optional components for multi-band antenna 100A depending on the electrical characteristics of high-band modified monopole antenna 30 and low-band modified monopole antenna 50.

As shown in FIG. 5, LC network 152 is connected between the first radio frequency input 150 and wireless communication circuit RF signal path 154. LC network 152 matches the multi-band antenna 100A of FIG. 3 to the impedance of wireless communication circuit RF signal path 154 (typically 50 ohms). LC network 156 is connected between the second radio frequency port 200 of high-band modified monopole antenna 30 and the fourth radio frequency port 210 of low-band modified monopole antenna 50. LC network 152 is an optional matching network for multi-band antenna 100A.

LC network 156 isolates (or matches with a high-impedance circuit) the high-band modified monopole antenna 30 from low-band modified monopole antenna 50 at their respective operating frequency bands. The circuit topology and values for the inductor(s) (L) and capacitor(s) (C) in LC networks 152 and 156 will depend on the input impedance of the first radio frequency port 150, of the second radio frequency port 200, of the third radio frequency port 220, and of the fourth radio frequency port 210 over the operating frequency ranges of low-band modified monopole antenna 50 and high-band modified monopole antenna 30. Inductor(s) L and capacitors (C) may be lumped or distributed circuit element. LC network 156 is an optional isolation network for multi-band antenna 100A.

In an alternate exemplary embodiment, in lieu of LC network 156, a switch, e.g., a single-pole multi-throw switch, (not shown) may be used to achieve antenna match. The switch is adjusted electronically to select an optimal match for the multi-band antenna (with 50 ohms) at a particular operative frequency band.

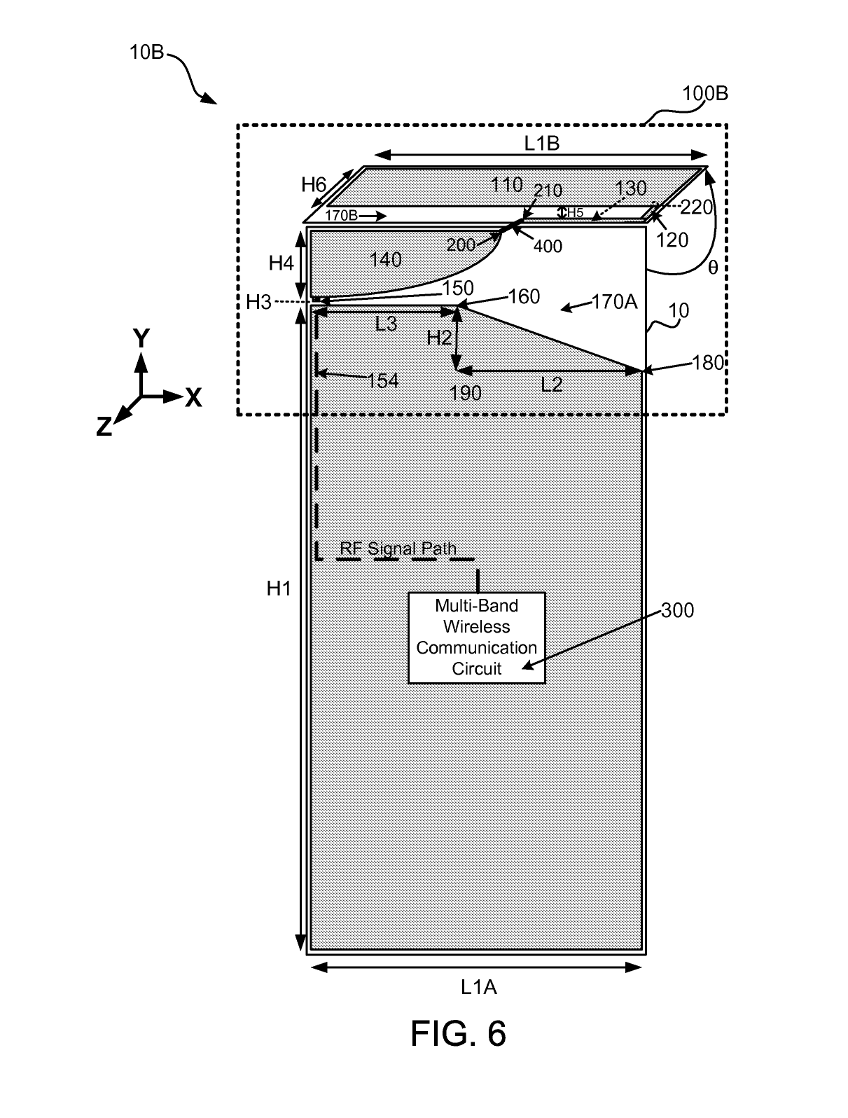

FIG. 6 shows a three dimensional drawing of the multi-band wireless communication device with the multi-band antenna formed by a serial connection of the high-band modified monopole antenna from FIG. 1 in the XY plane and the low-band modified monopole antenna from FIG. 2 rotated θ degrees in the YZ plane in accordance with the exemplary embodiment as shown. As shown previously in relation to FIGS. 3-4, L1B is equal to L1A. In typical design embodiments, θ equals +/−90 degrees (printed circuit board 170A is normal to printed circuit board 170B), however other values of θ may be utilized.

As shown in FIG. 6, high-band modified monopole antenna 30 is connected to low-band modified monopole antenna 50 utilizing a conductor 400 between the second radio frequency port 200 and the third radio frequency port 210. The electrical length of conductor 400 may impact the coupling and isolation between high-band modified monopole antenna 30 and low-band modified monopole antenna 50. Conductor 400 may be a connection via between layers of printed circuit board(s) 170A and 170B. Alternatively conductor 400 may be a wire, coax cable, flex circuit, or the like.

In the instance where the electrical length of conductor 400 affects the coupling between high-band modified monopole antenna 30 and low-band modified monopole antenna 50, LC network 156 (a high-impedance circuit) may be added between conductor 400 and the second radio frequency port 200 or the fourth radio frequency port 210 to tune to a high-impedance at the second radio frequency port 200 in the operating frequency range of high-band modified monopole antenna 30. Although not shown in FIG. 6, LC network 152 may be connected between the first radio frequency port 150 and wireless communication circuit RF signal path 154 to match the multi-band antenna 100B to wireless communication circuit RF signal path 154 (typically 50 ohms).

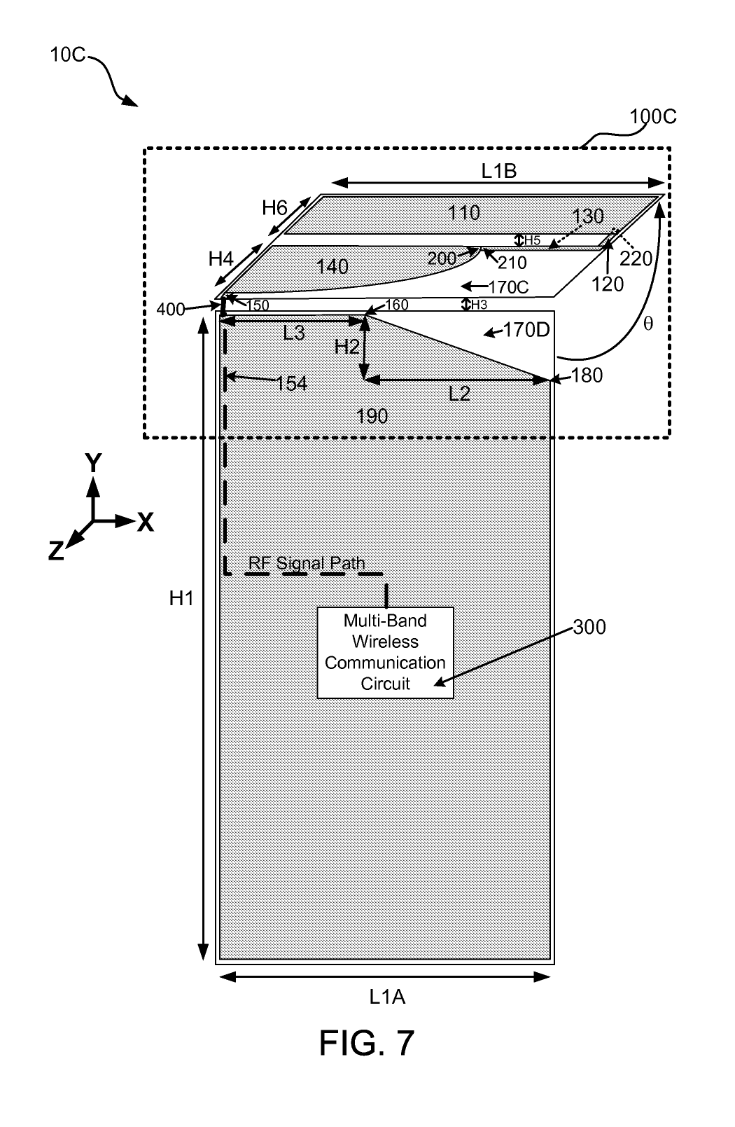

FIG. 7 shows a three dimensional drawing of the multi-band wireless communication device with the multi-band antenna formed by a serial connection of the high-band modified monopole antenna from FIG. 1 and the low-band modified monopole antenna from FIG. 2, both antenna elements rotated θ degrees in the YZ plane relative to the ground plane in the XY plane in accordance with the exemplary embodiment as shown. As shown previously in relation to FIGS. 3-4, L1B is equal to L1A. In typical design embodiments, θ equals +/−90 degrees (printed circuit board 170C is normal to printed circuit board 170D), however other values of θ may be utilized.

It is also conceivable that low-band modified monopole antenna 50 may be folded relative to high-band modified monopole antenna 30 and ground plane 190 to change the overall physical dimensions and volume of multi-band antenna 100C (not shown). However, the coupling between high-band modified monopole antenna 30, low-band modified monopole antenna 50, and ground plane 190 will increase, and may lead to a reduction in antenna radiated efficiency and operating frequency range for multi-band antenna 100C.

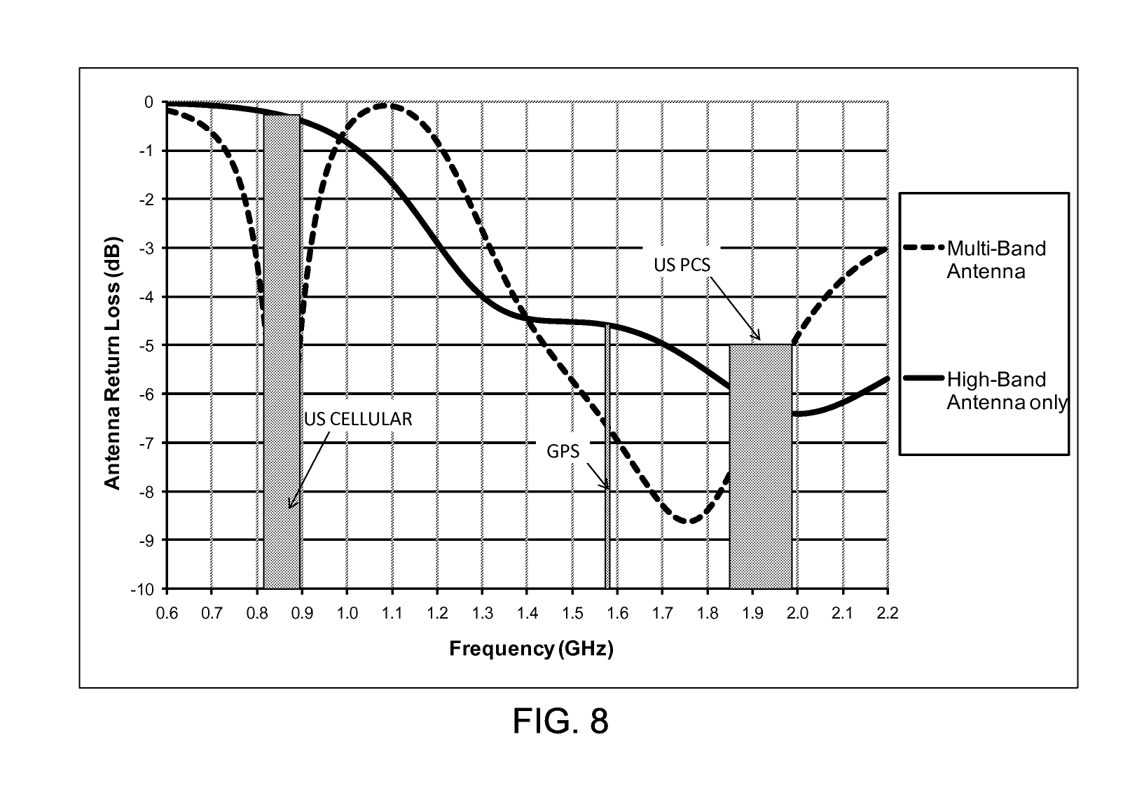

FIG. 8 shows a graph of the high-band modified monopole antenna and multi-band antenna return loss (0.6 to 2.2 GHz) for the antenna elements shown in FIGS. 1-4 in accordance with the exemplary embodiment as shown. In the case of high-band modified monopole antenna 30 from FIG. 1, the graph shows that the measured antenna return loss is approximately −4.6 dB at 1575 MHz (GPS), and −5.8 to −6.4 dB for 1850-1990 MHz (PCS) and may also operate at frequencies up to 2400 MHz (IMT and almost 802.11bg WLAN operating bands).

Further return loss optimization (utilizing LC networks 152 and 156) could improve the performance in select frequency bands, but the example design demonstrates the broadband frequency coverage of high-band modified monopole antenna 30. Obviously lower return loss translates into greater antenna radiated efficiency and impedance matching between multi-band antenna 100A and multi-band wireless communication circuit 300.

In the second instance, low-band modified monopole antenna 50 (of FIG. 2) is added to high-band modified monopole antenna 30 (of FIG. 1) to form multi-band antenna 100A (of FIG. 3) a measured antenna return loss as shown in FIG. 8. The measured antenna return loss is approximately −5.3 to −7.7 dB across the US cellular frequency band (824-894 MHz), −6.7 dB at 1575 MHz (GPS), and −5 to −7.6 dB across the US PCS frequency band (1850-1990 MHz). High-band operating frequency range is reduced (relative to high-band modified monopole antenna 30) when low-band modified monopole antenna 50 is coupled in series with high-band modified monopole antenna 30; however the measured antenna return loss is acceptable for a broadband printed antenna (even without LC networks 152 and 156 in this example).

FIG. 8 demonstrates that the series connected high-band modified monopole antenna 30 (of FIG. 1) and low-band modified monopole antenna 50 (of FIG. 2) forms a multi-band antenna 100A (of FIG. 3) with suitable antenna return loss across a broad range of operating frequency bands and can be further optimized through design iterations, introducing LC networks 152 and 156, and/or electro-magnetic simulation on a computer workstation.

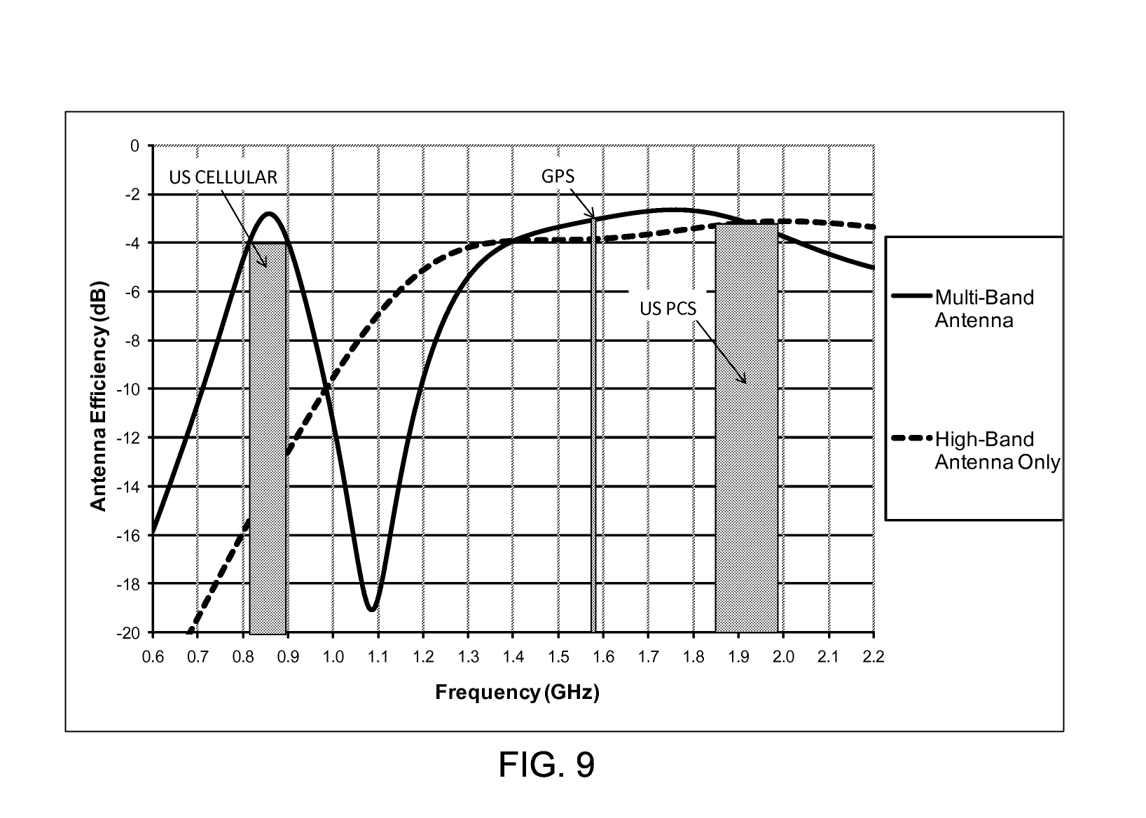

FIG. 9 shows a graph of the high-band modified monopole antenna and multi-band antenna radiation efficiency (0.6 to 2.2 GHz) for the antenna elements shown in FIGS. 1-4 in accordance with the exemplary embodiment as shown. In the case of high-band modified monopole antenna 30 from FIG. 1, the graph shows that the measured antenna radiated efficiency is approximately −3.9 dB at 1575 MHz (GPS), and −3.3 to −3.1 dB for 1850-1990 MHz (PCS) and may also operate at frequencies up to 2400 MHz (IMT and almost 802.11bg WLAN operating bands with antenna radiated efficiency better than −3.4 dB). As discussed previously in relation to FIG. 8, further antenna radiated efficiency optimization could improve the performance in select frequency bands, but the example design demonstrates the broadband frequency coverage of high-band modified monopole antenna 30.

In the second instance, low-band modified monopole antenna 50 (of FIG. 2) is added to high-band modified monopole antenna 30 (of FIG. 1) to form a multi-band antenna 100A (of FIG. 3) with a measured radiation antenna efficiency as shown in FIG. 9. The antenna radiated efficiency is approximately −2.8 to −3.6 dB across the US cellular frequency band (824-894 MHz), −3.1 dB at 1575 MHz (GPS), and −2.8 to −3.7 dB across the US PCS frequency band (1850-1990 MHz).

High-band modified monopole antenna 30 measured antenna radiated efficiency is actually improved from 1400 MHz to approximately 2000 MHz when low-band modified monopole antenna 50 is connected in series. Coupling between antenna elements can improve overall performance in some design examples.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the exemplary embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A multi-band antenna including a high-band antenna and a low-band antenna coupled in serial cascade fashion, where the low-band antenna is coupled at a position relative to the high-band antenna characterized by low coupling between the low-band antenna and the high-band antenna in corresponding operating frequency bands.

2. The multi-band antenna of claim 1, wherein the high-band antenna is a high-band modified monopole antenna.

3. The multi-band antenna of claim 2, wherein the high-band modified monopole antenna is a high-band quarter ellipse monopole antenna element.

4. The multi-band antenna of claim 3, wherein the low-band antenna is a low-band modified monopole antenna.

5. The multi-band antenna of claim 2, wherein the high-band modified monopole antenna includes a high-band quarter ellipse monopole antenna element with a first radio frequency port near a first vertex of the high-band quarter ellipse monopole antenna element curve closest to a ground plane, and a second radio frequency port near a second vertex of the high-band quarter ellipse monopole antenna element curve furthest from the ground plane.

6. The multi-band antenna of claim 5, further comprising a high-impedance circuit coupled between the second radio frequency port of the high-band quarter ellipse monopole antenna element and a third radio frequency port of the low-band modified monopole antenna.

7. The multi-band antenna of claim 6, wherein the high-impedance circuit includes distributed circuit elements.

8. The multi-band antenna of claim 5, further comprising a LC network coupled to the second radio frequency port of the high-band quarter ellipse monopole antenna element and a third radio frequency port of the low-band modified monopole antenna.

9. The multi-band antenna of claim 5, further comprising a switch between the second radio frequency port of the high-band quarter ellipse monopole antenna element and a third radio frequency port of the low-band modified monopole antenna.

10. The multi-band antenna of claim 5, wherein the multi-band antenna includes a wireless communication circuit RF signal path coupled to the first radio frequency port of the high-band quarter ellipse monopole antenna element.

11. The multi-band antenna of claim 10, further comprising a LC network disposed between the first radio frequency port and the wireless communication circuit RF signal path for matching the input impedance at the first radio frequency port with the input impedance of the wireless communication circuit RF signal path.

12. The multi-band antenna of claim 5, wherein the ground plane, the high-band quarter ellipse monopole antenna element, and the low-band modified monopole antenna are not co-planar.

13. The multi-band antenna of claim 12, wherein the ground plane is in the XY plane, the high-band quarter ellipse monopole antenna element is in the XZ plane, and the low-band modified monopole antenna is folded over the ground plane in the XY plane with a gap proportional to a short axis of the high-band quarter ellipse monopole antenna element.

14. The multi-band antenna of claim 5, wherein the ground plane and high-band quarter ellipse monopole antenna element are co-planar in the XY plane, but not to the low-band antenna.

15. The multi-band antenna of claim 14, wherein the low-band modified monopole antenna is in the XZ plane and normal to the ground plane and the high-band quarter ellipse monopole antenna element.

16. The multi-band antenna of claim 5, wherein the ground plane, the high-band quarter ellipse monopole antenna element, and the low-band modified monopole antenna are co-planar in the XY plane.

17. The multi-band antenna of claim 5, wherein the high-band quarter ellipse monopole antenna element and the low-band modified monopole antenna are co-planar in the XZ plane and normal to the ground plane in the XY plane.

18. The multi-band antenna of claim 5, wherein the multi-band antenna is formed as a three dimensional metallized structure.

19. The multi-band antenna of claim 5, wherein the ground plane, the high-band quarter ellipse monopole antenna element, and the low-band modified monopole antenna are embedded on multiple layers of a printed circuit board and interconnected by metal vias between the multiple layers of the printed circuit board.

20. The multi-band antenna of claim 5, wherein the multi-band antenna is etched on at least one flexible membrane.

21. The multi-band antenna of claim 5, wherein the multi-band antenna is etched on at least one dielectric substrate.

22. The multi-band antenna of claim 5, wherein the multi-band antenna is deposited on at least one housing surface within a wireless communication device.

23. The multi-band antenna of claim 5, wherein the multi-band antenna is a part of a handheld wireless communication device.

24. The multi-band antenna of claim 5, wherein the multi-band antenna is part of a portable computer with an embedded wireless communication device.

25. A wireless communication device including a multi-band antenna comprised of a high-band antenna and a low-band antenna coupled in serial cascade fashion, where the low-band antenna is coupled at a position relative to the high-band antenna characterized by low coupling between the low-band antenna and the high-band antenna in corresponding operating frequency bands.

26. The wireless communication device of claim 25, wherein the high-band antenna is a high-band quarter ellipse monopole antenna element.

27. The wireless communication device of claim 26, wherein the low-band antenna is a low-band modified monopole antenna.

28. The wireless communication device of claim 27, wherein the high-band quarter ellipse monopole antenna element includes a first radio frequency port near a first vertex of the high-band quarter ellipse monopole antenna element curve closest to a ground plane, and a second radio frequency port near a second vertex of the high-band quarter ellipse monopole antenna element curve furthest from the ground plane.

29. The wireless communication device of claim 28, further comprising a high-impedance circuit coupled between the second radio frequency port of the high-band quarter ellipse monopole antenna element and a third radio frequency port of the low-band modified monopole antenna.

30. The wireless communication device of claim 29, wherein the multi-band antenna is formed as a three dimensional metallized structure.

31. The wireless communication device of claim 29, wherein the ground plane, the high-band quarter ellipse monopole antenna element, and the low-band modified monopole antenna are embedded on multiple layers of a printed circuit board and interconnected by metal vias between the multiple layers of the printed circuit board.

32. The wireless communication device of claim 25, wherein the multi-band antenna is etched on at least one flexible membrane.

33. The wireless communication device of claim 25, wherein the multi-band antenna is etched on at least one dielectric substrate.

34. The wireless communication device of claim 33, wherein the multi-band antenna is deposited on at least one housing surface within a wireless communication device.

35. The wireless communication device of claim 34, wherein the wireless communication device is a handheld wireless communication device.

36. The wireless communication device of claim 35, wherein the wireless communication device is part of a portable computer with at least one multi-band antenna embedded thereon.
